(19) United States
(12) Patent Application Publication
(10) Pub. No.: US 2004/0161673 A1
(43) Pub. Date: Aug. 19, 2004

(54) Alkaline storage battery

(76) Inventors: Katsuhiko Shinyama, Kobe-city (JP); Kiyoshi Kumagae, Kobe-city (JP); Tadayoshi Tanaka, Takatuki-city (JP); Yoshifumi Magari, Kobe-city (JP); Hiroshi Nakamura, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006

(21) Appl. No.: 10/776,596

(22) Filed: Feb. 12, 2004

(30) Foreign Application Priority Data
Feb. 13, 2003 (JP) 2003-034578

(51) Int. Cl. H01M 10/26

(52) U.S. Cl. 429/347; 429/206

(57) ABSTRACT

An alkaline storage battery which includes a positive electrode, a negative electrode including a hydrogen absorbing alloy containing manganese as an active material, a separator and an alkaline electrolyte and contains a complex-forming agent which does not include nitrogen and which creates a complex with manganese.

### FIELD OF THE INVENTION

The present invention relates to an alkaline storage battery comprising a positive electrode, a negative electrode which includes, as an active material, a hydrogen absorbing alloy containing manganese, a separator and an alkaline electrolyte. More particularly, the present invention relates to an alkaline storage battery of the foregoing type which is characterized in that manganese, which is released from the hydrogen absorbing alloy by charge and discharge of the battery, is prevented from depositing on the separator and preventing self discharge.

### BACKGROUND OF THE INVENTION

An alkaline storage battery has recently been used for cellular phones, electric vehicles, and the like. As the alkaline storage battery, an alkaline storage battery comprising a hydrogen absorbing alloy as a material of a negative electrode is preferably used from the standpoints of higher capacity and improved environmental safety as compared to a nickel cadmium storage battery.

There is, however, a problem with such an alkaline storage battery that when the battery is repeatedly charged and discharged, metal included in the hydrogen absorbing alloy used for the negative electrode is partially dissolved in the alkaline electrolyte as metal ions. These metal ions deposit on the separator to cause self discharge and deterioration of storage characteristics.

As described in Japanese Patent Laid-open Publication Nos. 4-284355 and 7-335245, an alkaline storage battery has been proposed in which a complex-forming agent, for example, an ethylene diamine derivative, and the like, which forms a complex with transition metal ions, is added to a hydrogen absorbing alloy electrode and an alkaline electrolyte.

However, when the alkaline storage battery includes a hydrogen absorbing alloy containing manganese, even if a complex-forming agent, for example, an ethylene diamine derivative, or the like, is added to the hydrogen absorbing alloy electrode and the alkaline electrolyte, there is still a self discharge problem which causes deterioration of storage characteristics.

### OBJECT OF THE INVENTION

An object of the present invention is to solve the above-described problem of an alkaline storage battery comprising a positive electrode, a negative electrode comprising, as an active material, a hydrogen absorbing alloy containing manganese, a separator and an alkaline electrolyte. Especially, it is an object of the present invention to prevent manganese ions from being deposited on the separator and to suppress self discharge and improve storage characteristics.

### SUMMARY OF THE INVENTION

In the present invention, in order to solve the above-described problems, a complex-forming agent which does not include nitrogen and which creates a complex with manganese is included in an alkaline storage battery comprising a positive electrode, a negative electrode including a hydrogen absorbing alloy containing manganese as an active material, a separator and an alkaline electrolyte.

### BRIEF DESCRIPTION OF THE DRAWINGS

FIG. 1 is a drawing illustrating a test cell prepared in a pre-experiment, Example 1 and Comparative Examples 1 and 2.

### EXPLANATION OF ELEMENTS

1: positive electrode

2: negative electrode

3a, 3b: separators

4: hydrogen absorbing alloy plate

5: alkaline electrolyte

10: container

### DETAILED EXPLANATION OF THE INVENTION

When manganese included in a hydrogen absorbing alloy of a negative electrode of an alkaline storage battery is released from the alloy as manganese ions during charge and discharge of the battery, if a complex-forming agent which does not contain nitrogen and which forms a complex with manganese is included in the battery, the manganese ions are efficiently captured by the complex-forming agent, even if the manganese ions dissolve in the alkaline electrolyte, and form a complex to prevent deposition of manganese on the separator. If a complex-forming agent not containing nitrogen is used, the complex-forming agent is prevented from being decomposed and releasing impurity ions and movement of impurity ions between the negative electrode and the positive electrode is also prevented.

As the results of inhibition of movement of impurity ions between the positive electrode and the negative electrode and of inhibition of deposition of manganese ions on the separator, self discharge is suppressed and storage characteristics are improved.

There is no limitation with respect to a location of the complex-forming agent included in the storage battery. It is preferable to provide the complex-forming agent in the alkaline electrolyte to efficiently capture manganese ions dissolved in the alkaline electrolyte.

There is no limitation with respect to the complex-forming agent if the complex-forming agent is capable of forming a complex with manganese and does not include nitrogen. For example, sodium lactate, lactic acid, thioglycolic acid, isocitric acid, and the like can be used. It is preferable to use sodium lactate.

As the separator, it is preferable to use a material having alkaline resistance, that is hydrophilic and that is capable of capturing impurity ions. It is also preferable that the separator is sulfonated.

### DESCRIPTION OF PREFERRED EMBODIMENT

### EXAMPLES

An example of an alkaline storage battery of the present invention is described below and is compared with those of comparative examples to show that self discharge of the battery is inhibited and storage characteristics of the battery are improved when the battery comprises a hydrogen absorbing alloy containing manganese for a negative electrode, and a complex-forming agent not containing nitrogen and which forms a complex with manganese is used. It is of course understood that the present invention can be modified within the scope and spirit of the appended claims.

(Pre-Experiment)

In this pre-experiment, an experiment is carried out to check that manganese contained in the hydrogen absorbing alloy is deposited on a separator by charge and discharge of a battery in which a hydrogen absorbing alloy containing manganese is used.

As a hydrogen absorbing alloy, particles of MmNi_{3.2}Co_{1.0}Al_{0.2}Mn_{0.6} comprising Misch Metal (Mm), which is a mixture of rare earth elements (La, Ce, Pr and Nd contained in a ratio by weight of 25:50:6:19), and Ni, Co, Al and Mn, and having an average diameter of about 50 μm were used. A small amount of water was added to a mixture of 100 parts by weight of the hydrogen absorbing alloy particles and 1.0 part by weight of poly(ethylene oxide) as a binder to prepare a paste. The paste was coated on both sides of a nickel plated punched metal as a current collector. The coated punched metal was pressed after drying and cut to a desired size to prepare a hydrogen absorbing alloy plate.

To prepare a positive electrode a sintered porous nickel substrate having a porosity of about 85% was immersed in a nickel nitrate solution containing cobalt nitrate and zinc nitrate by a chemical immersing method to impregnate the sintered nickel substrate with nickel hydroxide containing cobalt and zinc. Then the sintered nickel substrate was cut to a desired size to prepare the positive electrode.

A sintered porous nickel substrate having a porosity of about 85% was impregnated with cadmium hydroxide and was cut to a desired size to prepare a sintered cadmium electrode as the negative electrode.

A sulfonated nonwoven fabric made of polypropylene and polyethylene was used for a separator.

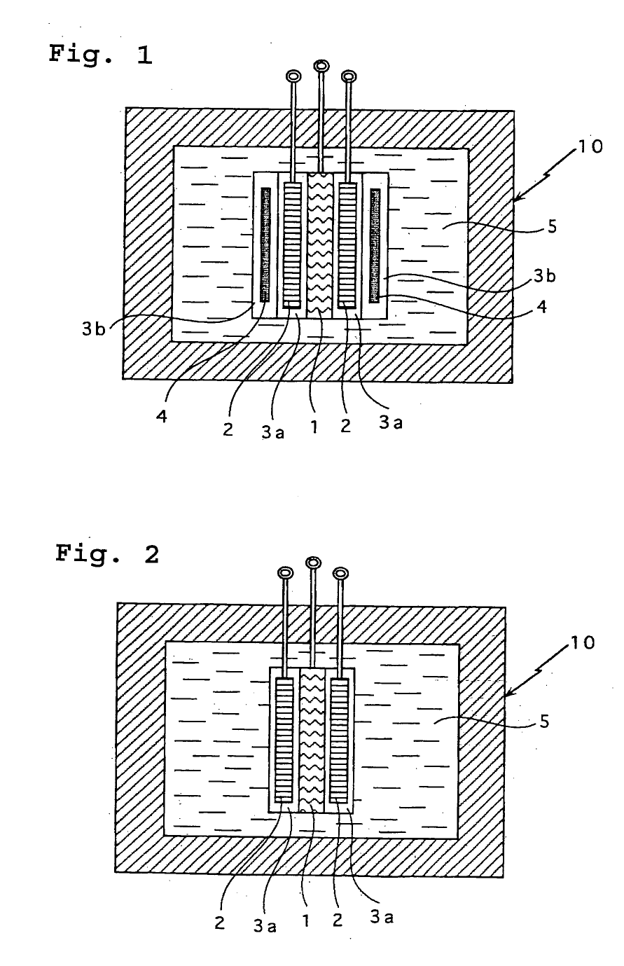

As shown in FIG. 1, negative electrodes 2 made of the sintered cadmium electrodes and covered with separators 3a were placed on both sides of the positive electrode 1 made of the sintered nickel electrode, and the hydrogen absorbing alloy plates 4 covered with separators 3b were placed in a container 10. 3 ml of an alkaline electrolyte 5 comprising 30 weight % of potassium hydroxide was poured in the container 10, and the container 10 was sealed to prepare a test cell A having a capacity of about 100 mAh.

As a test cell B, as shown in FIG. 2, a cell having a capacity of about 100 mAh was prepared in the same manner as the test cell A except that the hydrogen absorbing alloy plates 4 covered with the separators 3b were not included.

The test cells A and B were charged at 10 mAh for 16 hours at 25° C., and were discharged to 1.0 V at 10 mAh. This charge and discharge cycle was considered one cycle, and 10 cycles of charge and discharge were repeated to activate the cells A and B.

Then, activated cells A and B were charged at 50 mA for 1.6 hours at 25° C., and were discharged to 1.0 V at 50 mA to obtain discharge capacity (Q1) of each cell before storage. Each cell was again charged at 50 mA for 1.6 hours at 25° C., was left at 45° C. for 7 days and then was discharged to 1.0 V at 50 mA at 25° C. to obtain discharge capacity (Q2) after storage.

A capacity maintenance rate of each cell was calculated by the following formula.

Capacity maintenance rate (%)=(Q2/Q1)×100

The separator 3a which covered the negative electrode 2 was removed from the cells A and B to determine an amount of manganese (cps/μA) contained in the separator 3a by an X-ray fluorescent analysis. The results are shown in Table 1.

TABLE 1

| | Hydrogen | Capacity | |
|---|---|---|---|
| | Absorbing | Maintenance | Mn Content |
| Test Cell | Alloy Plate | Rate (%) | (cps/μA) |
| A | Yes | 20 | 1.3 |
| B | No | 80 | 0 |

As is clear from the results, manganese contained in the hydrogen absorbing alloy plate 4 in the test cell A was released, and was deposited on the separator 3a, and the capacity maintenance rate was significantly reduced. It is believed that manganese deposited on the separator 3a caused self discharge.

### Example 1

A test cell of Example 1 was prepared in the same manner as the test cell A shown in FIG. 1 except that 0.1 g of sodium lactate as a complex-forming agent was added to 3 ml of the alkaline electrolyte comprising 30 weight % of potassium hydroxide.

### Comparative Example 1

A test cell of Comparative Example 1 was prepared in the same manner as the test cell A shown in FIG. 1 except that 0.1 g of ethylenediaminetetraacetic acid (EDTA) was added to 3 ml of the alkaline electrolyte comprising 30 weight % of potassium hydroxide.

### Comparative Example 2

A test cell of Comparative Example 2 was prepared in the same manner as the test cell A except that no complex-forming agent was added to the alkaline electrolyte.

Test cells of Example 1 and Comparative Examples 1 and 2 were activated in the same manner as the test cell A.

The activated test cells of Example 1 and Comparative Examples 1 and 2 were charged at 50 mA for 1.6 hours at 25° C., were left at 45° C. for 4 days, and then the battery voltage of each cell was measured. The results are shown in Table 2.

The separator 3a which covered the negative electrode 2 was removed from each cell of Example 1 and Comparative Examples 1 and 2 to determine an amount of manganese (cps/μA) contained in the separator 3a by X-ray fluorescent analysis. The results are also shown in Table 2.

TABLE 2

| | | Battery | |
|---|---|---|---|
| | | Voltage | Mn Content |
| Test Cell | Additive | (V) | (cps/μA) |
| Example 1 | Sodium lactate | 1.242 | 0 |
| Comparative | EDTA | 1.035 | 0.77 |
| Example 1 | | | |
| Comparative | — | 1.228 | 0.80 |
| Example 2 | | | |

As is clear from the results, in the test cell in which sodium lactate was added to the alkaline electrolyte, manganese was not deposited on the separator 3a as contrasted to that of each of Comparative Example 1 in which EDTA was added to the alkaline electrolyte and Comparative Example 2 in which no additive was added to the alkaline electrolyte. In Example 1, self discharge was suppressed and battery voltage after storage was higher than that of Comparative Examples 1 and 2.

Although EDTA was added to the alkaline electrolyte in the test cell of Comparative Example 1, manganese was not captured and an amount of manganese was deposited on the separator 3a similar to that of Comparative Example 2 in which no additive was added to the alkaline electrolyte. The battery voltage of comparative Example 1 after storage was lower than that of Comparative Example 2. It is believed that EDTA was decomposed and created impurity ions. The impurity ions traveled between the positive electrode 1 and the negative electrode 2, and self discharge occurred.

0.1 g of sodium lactate was added to the alkaline electrolyte in Example 1 as described above. If an amount of sodium lactate is too small, manganese dissolved in the alkaline electrolyte can not be sufficiently captured and self discharge cannot be sufficiently inhibited. However, if an amount of sodium lactate is too high, electronic conductivity of the alkaline electrolyte is decreased. Therefore, it is preferable to add sodium lactate in a range of 10˜200 mg/l to the alkaline electrolyte.

In the above experiments, the effects of additives (complex-forming agent) with respect to a hydrogen absorbing alloy plate containing manganese were evaluated in test cells in which a sintered cadmium electrode was used as the negative electrode. When the hydrogen absorbing alloy is used as the negative electrode in an alkaline storage battery, it is of course understood that the same results can be obtained.

### ADVANTAGES OF THE INVENTION

As described in detail, the alkaline storage battery of the present invention contains a complex-forming agent not containing nitrogen and which forms a complex with manganese so that even if manganese ions are released from the negative electrode comprising a hydrogen absorbing alloy containing manganese, the manganese ions are captured by forming a complex with the complex-forming agent to inhibit deposition of manganese on the separator.

When the complex-forming agent not containing nitrogen is used, decomposition of the complex-forming agent to create impurity ions is suppressed, and there is not movement of impurity ions between the positive electrode and the negative electrode.

Storage characteristics of the alkaline storage battery are remarkably improved by inhibition of deposition of manganese on the separator and prevention of movement of impurity ions generated by decomposition of the complex-forming agent.

What is claimed is:

1. An alkaline storage battery comprising a positive electrode, a negative electrode comprising, as an active material, a hydrogen absorbing alloy containing manganese, a separator and an alkaline electrolyte, and containing a complex-forming agent which does not contain nitrogen and capable of forming a complex with manganese.

2. The alkaline storage battery according to claim 1, wherein the complex-forming agent is contained in the alkaline electrolyte.

3. The alkaline storage battery according to claim 1, wherein the complex-forming agent is selected from the group consisting of sodium lactate, lactic acid, thioglycolic acid and isocitric acid.

4. The alkaline storage battery according to claim 2, wherein the complex-forming agent is selected from the group consisting of sodium lactate, lactic acid, thioglycolic acid and isocitric acid.

5. The alkaline storage battery according to claim 3, wherein the complex-forming agent is sodium lactate.

6. The alkaline storage battery according to claim 4, wherein the complex-forming agent is sodium lactate.

7. The alkaline storage battery according to claim 6, wherein a concentration of sodium lactate in the alkaline electrolyte is in a range of 10˜200 mg/l.
